(19) United States
(12) Patent Application Publication
(10) Pub. No.: US 2010/0194522 A1
(43) Pub. Date: Aug. 5, 2010

(54) RESETTABLE FUSE WITH TEMPERATURE COMPENSATION

(75) Inventor: John L. Janning, Bellbrook, OH (US)

Correspondence Address: DICKSTEIN SHAPIRO LLP, 1825 EYE STREET NW, Washington, DC, 20006-5403, US

(73) Assignee: JLJ. Inc.

(21) Appl. No.: 12/759,577

(22) Filed: Apr. 13, 2010

Related U.S. Application Data
(60) Provisional application No. 61/341,293, filed on Mar. 29, 2010.

(51) Int. Cl. H01C 7/13

(52) U.S. Cl. 338/22 R

(57) ABSTRACT

A temperature compensated device to prevent overcurrent in electrical circuits in very cold conditions. The device includes a PTC thermistor to control current through a circuit. A negative temperature coefficient (NTC) thermistor is thermally coupled to a PTC thermistor to ‘warm’ the PTC thermistor in cold environments. When circuit current flows in the NTC thermistor, the NTC thermistor will heat up, thus warming the PTC thermistor. The PTC thermistor may then operate as designed and prevent overcurrent in an electrical circuit.

### CROSS-REFERENCE TO RELATED APPLICATIONS

This application claims the benefit of U.S. Provisional Application No. 61/341,293, filed on Mar. 29, 2010, the entire disclosure of which is incorporated by reference herein.

### FIELD OF THE INVENTION

The present invention relates to a resettable fuse with temperature compensation which may be used in cold environments, such as Christmas lighting.

### BACKGROUND OF THE INVENTION

The positive temperature coefficient (PTC) thermistor resettable fuse is a device used to protect against overcurrent faults in electronic circuits. These are non-linear conductive devices that switch from a very low resistance conductive state to a very high resistance state when an overcurrent condition occurs. They cycle back to a conductive state after the current is removed, acting like circuit breakers, allowing the circuit to function again without replacing anything like one would need to do in the case of standard fuses.

PTC resettable fuses operate very nicely at room temperature. However, in an environment where there are very low temperatures, they can allow excessive current to flow in a circuit without tripping at their designed tripping current. Thus, the electronic or electric circuit they are incorporated in to protect is at risk.

A resettable fuse that operates at very low temperatures is therefore needed.

### SUMMARY OF THE INVENTION

The present invention provides a device for preventing overcurrent in a circuit. The device includes a resettable fuse and a resistive element thermally coupled to the resettable fuse so that heat generated from current passing through the resistive element warms the resettable fuse. The resettable fuse may be a positive temperature coefficient thermistor and the resistive element may be a negative temperature coefficient thermistor. Alternatively, the resistive element may simply be a resistor.

The positive temperature coefficient thermistor may have a holding current rating of approximately 1.5 amperes and a trip current rating of approximately 3 amperes and the negative temperature coefficient thermistor may have a room temperature resistance of approximately one ohm or in some cases a fraction of an ohm.

The device of the present invention may be used for preventing overcurrent in a series-wired Christmas light string. In such a circuit, a resistive element, such as an NTC thermistor, is thermally coupled to the PTC thermistor element and disposed in electrical series connection with the PTC thermistor so that so that heat generated from current passing through the resistive element warms the resettable fuse. Further, the device may be located in a plug of the Christmas light string.

Other features and advantages will become apparent from the following description, which refers to the accompanying drawings.

### BRIEF DESCRIPTION OF THE DRAWINGS

FIG. 1 illustrates a resettable fuse with temperature compensation;

FIG. 2 illustrates the physical layers of a resettable fuse with temperature compensation;

FIG. 3 illustrates a resettable fuse with temperature compensation in a circuit diagram;

FIG. 4 illustrates a resettable fuse with temperature compensation in a plug of a Christmas tree light string; and

FIG. 5 illustrates another embodiment of a resettable fuse with temperature compensation.

### DETAILED DESCRIPTION OF THE PREFERRED EMBODIMENT

In the following detailed description, reference is made to a specific embodiment that may be practiced. This embodiment is described with sufficient detail to enable those skilled in the art to practice the invention and it is to be understood that other embodiments may be employed, and that structural and logical changes may be made without departing from the spirit or scope of the present invention.

In accordance with a preferred embodiment of the present invention, a resettable fuse comprised of a positive temperature coefficient (PTC) thermistor is connected in electrical series with Christmas lights in a light string to prevent overcurrent through the light string. During normal operation of a PTC thermistor, numerous carbon paths within the polymer of the PTC thermistor allow the device to conduct electricity. As current through the PTC thermistor reaches its rated threshold, the polymer material begins to heat causing the polymer to expand. The resulting expansion breaks the carbon chains to reduce the current through the circuit to a small leakage current. The increased resistance in the PTC thermistor works to protect circuitry by limiting potentially damaging current. When the fault (overcurrent) is removed from the circuit, and the power disconnected, the PTC thermistor will reset itself when it cools off and contracts to reestablish the carbon chains, thereby allowing current to flow through the circuit again when power is restored.

In some series-wired light strings, as bulbs are removed or shorted out, current passes through shunts and an overcurrent condition can occur. Likewise, if multiple strings are placed end to end, current increases through the light string. If a resettable fuse, such as a PTC thermistor is series-wired in the string, a point is reached where the resistance of the PTC thermistor increases to limit current through the string, due to an internal temperature rise because of the increased current. However, if the light string is located in a very cold environment, then the polymer of the PTC thermistor may not expand and the current will not be reduced.

In these very cold conditions, a negative temperature coefficient (NTC) thermistor may be coupled to a PTC thermistor resettable fuse for ‘warming’ purposes. For example, a one ohm NTC thermistor is thermally coupled to a PTC thermistor resettable fuse designed to hold at one ampere and trip at two amperes. These two devices are wired in electrical series connection. At room temperature, the one ohm resistance of the NTC thermistor dissipates very little power—which in turn lowers its resistance resulting in even less dissipation. Therefore, it barely affects the circuit. However, at very cold temperatures, the one ohm NTC thermistor may exhibit a resistance far greater—for example, 10 ohms. With the circuit current flowing through the 10 ohms, the NTC thermistor heats due to I²R losses, thus warming the PTC thermistor resettable fuse. The PTC thermistor can now operate as designed. At extremely low temperatures, the I²R losses are small because R is so small and the cold environment cannot be overcome. The simple warming bias provided by the NTC thermistor in intimate contact with the PTC material solves the problem.

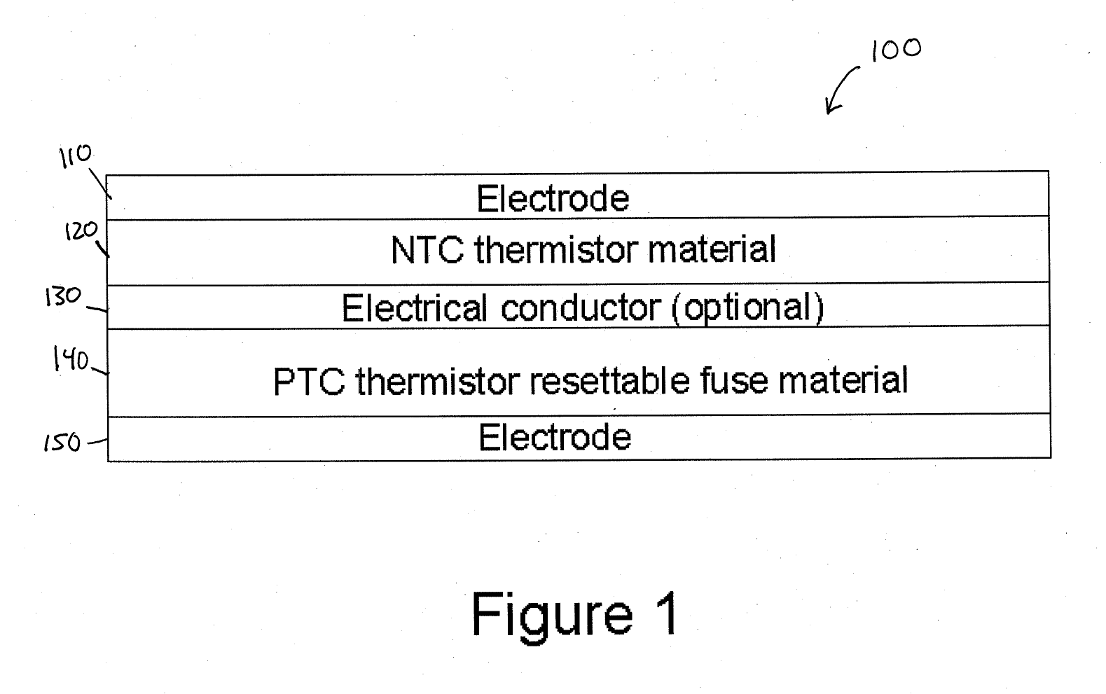

Referring now to the drawings, where like elements are designated by like reference numerals, FIG. 1 illustrates the construction of a dual NTC-PTC thermistor 100 of the present invention that effectively transfers the operational heat needed to overcome extremely cold temperatures with resettable fuses. The dual thermistor 100 comprises a first electrode 110 disposed in electrical series with a NTC thermistor material 120. The NTC thermistor material 120 is stacked on an electrical conductor 130, which is stacked on a PTC thermistor material 140. The PTC thermistor 140 is stacked on a second electrode 150. In another embodiment, there is no electrical conductor 130. In another embodiment, an individually packaged PTC thermistor and an individually packaged NTC thermistor may be used by coupling them via heat conducting adhesive.

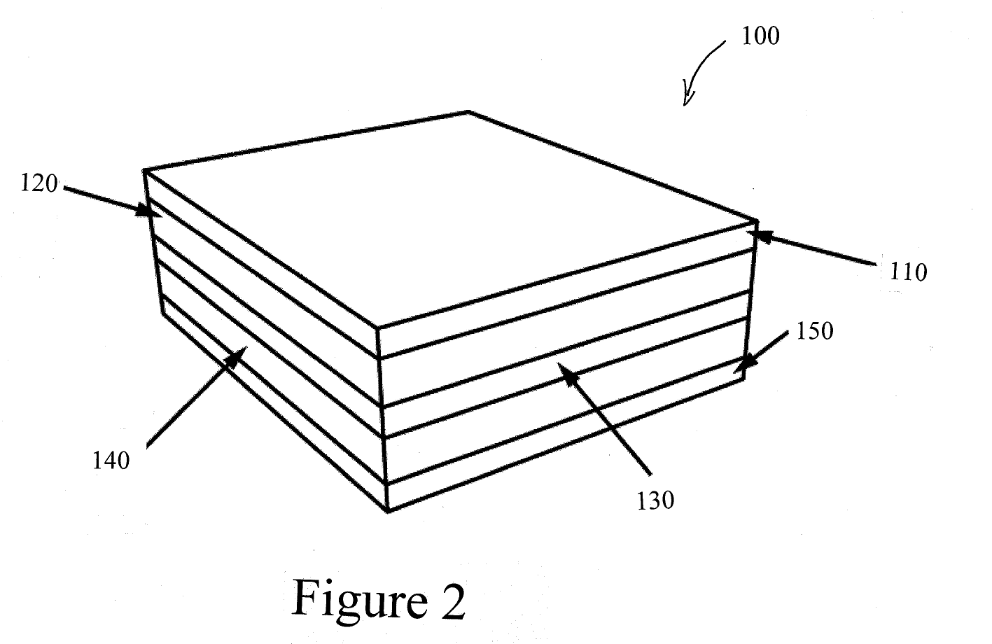

Such a combination of an NTC thermistor coupled to a PTC thermistor resettable fuse is very useful in overcurrent protection in Christmas light strings. In manufacturing, as illustrated in FIG. 2, a first electrode 150 is applied to one side of the resettable fuse “pellet” 140 followed by an electrical conductor 130 being applied to the other side of the pellet 140. Then, NTC thermistor 120 is applied to the electrical conductor 130 followed by a second electrode 110 being applied to the opposite side of the NTC thermistor 120, thereby completing the dual NTC-PTC thermistor 100.

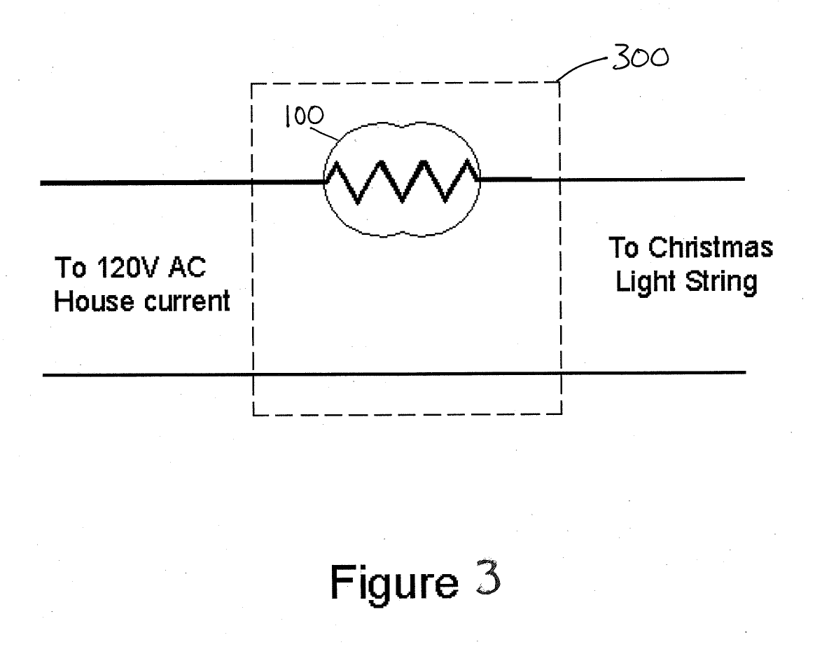

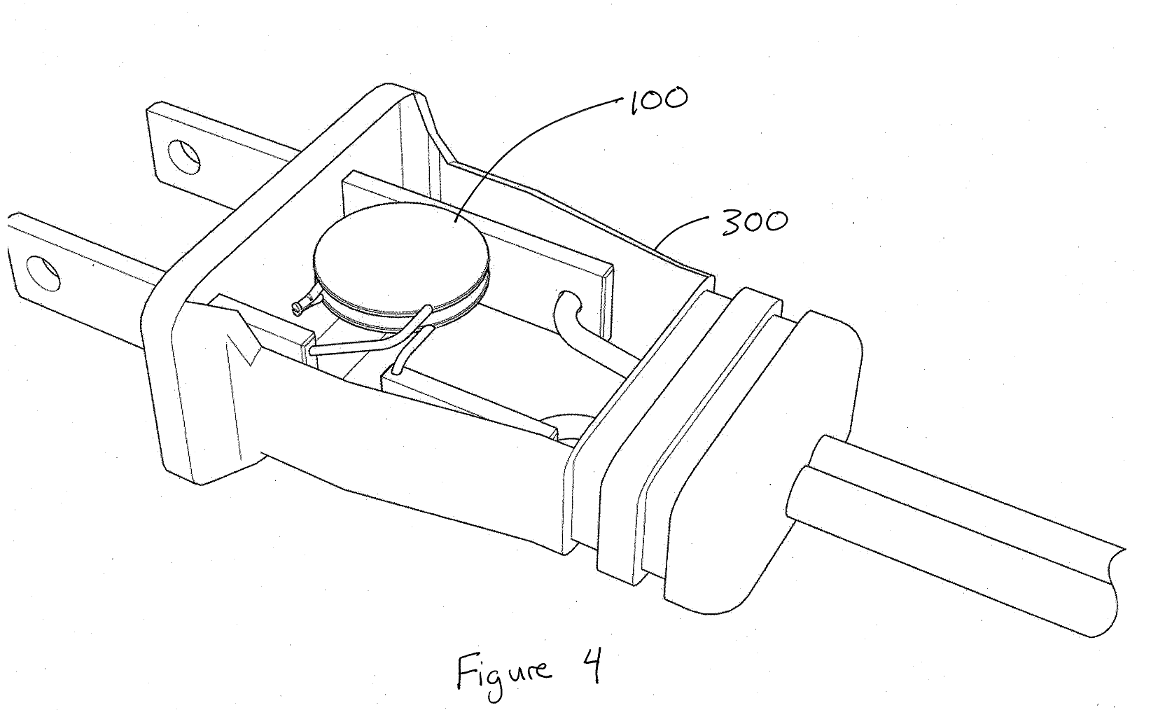

FIG. 3 shows a circuit diagram of a dual thermistor 100 installed in the 120 volt A.C. plug 300 as used in Christmas light strings. FIG. 4 shows a dual thermistor 100 installed in the 120 volt A.C. plug 300 as used in Christmas light strings. The NTC thermistor used in this invention, for this purpose, would have a room temperature resistance about one ohm for Christmas light strings with the PTC thermistor resettable fuse having a holding current rating of approximately 1.5 amperes and a trip current rating of approximately 3 amperes or less. In some cases, the NTC thermistor room temperature resistance may need to be a fraction of an ohm.

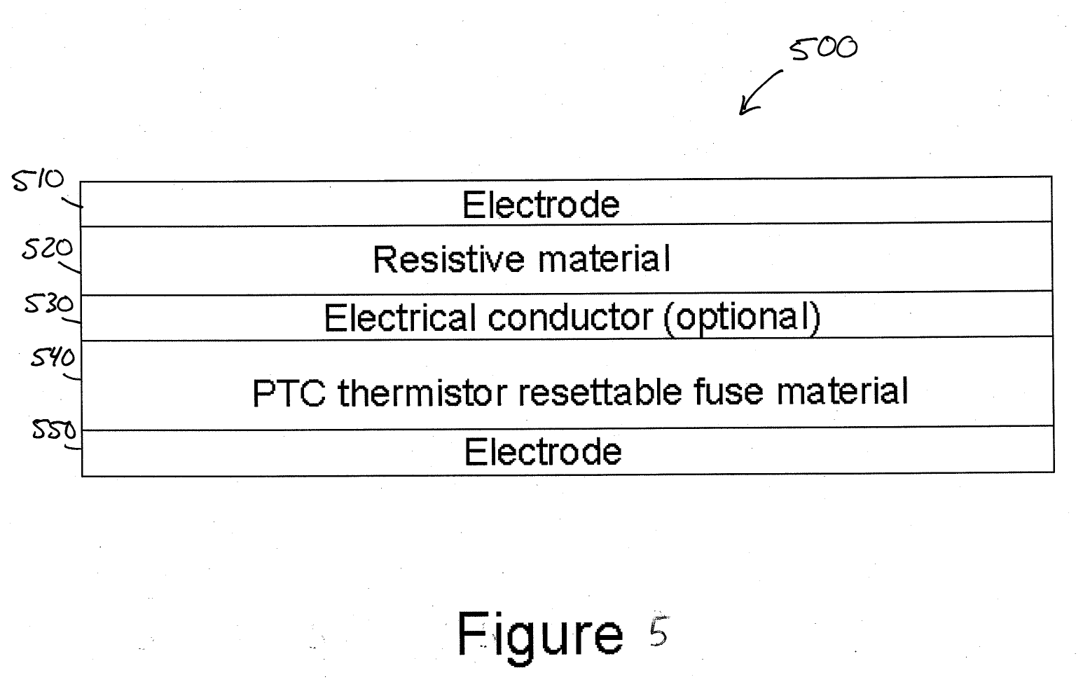

FIG. 5 shows another embodiment of a dual thermistor 500. The dual thermistor 500 comprises of a first electrode 510 disposed in electrical series with a resistive element 520. The resistive element 520 is stacked on an electrical conductor 530, which is stacked on a PTC thermistor material 540. The PTC thermistor 540 is stacked on a second electrode 550. In this embodiment, as current flows through the resistive element 520, the resistive element 520 heats due to I²R losses and thereby warms the PTC thermistor 540. The PTC thermistor 540 can now operate as designed and provide overcurrent protection as described above. In another embodiment, there is no electrical conductor 530.

The above description and the drawings illustrate only exemplary and/or preferred embodiments that achieve various objects, features, and advantages. It is not intended that the present invention be limited to the illustrated embodiments.

What is claimed as new and desired to be protected by Letters Patent of the United States is:

1. A temperature compensated device for preventing overcurrent through an electrical circuit, comprising:
a positive temperature coefficient thermistor; and
a resistive element thermally coupled to the positive temperature coefficient thermistor so that heat generated from current passing through the resistive element warms the resettable fuse.

2. The device of claim 1, wherein the resistive element is a negative temperature coefficient thermistor.

3. The device of claim 1, wherein the resistive element is a resistor.

4. The device of claim 1, wherein the electrical circuit is a series wired Christmas light string.

5. The device of claim 4, wherein the device is disposed in a plug of the Christmas light string.

6. The device of claim 1, wherein the positive temperature coefficient thermistor has a holding current rating of approximately 1.5 amperes and a trip current rating of approximately 3 amperes.

7. The device of claim 2, wherein the negative temperature coefficient thermistor has room temperature resistance of approximately one ohm or less.

8. A device for preventing overcurrent in a series-wired Christmas light string comprising:
a positive temperature coefficient thermistor; and
a resistive element thermally coupled to the positive temperature coefficient thermistor so that heat generated from current passing through the resistive element warms the positive temperature coefficient thermistor.

9. The device of claim 8, wherein the resistive element is a negative temperature coefficient thermistor.

10. The device of claim 8, wherein the resistive element is a resistor.

11. The device of claim 8, wherein the device is located in a plug of the Christmas light string.

12. The device of claim 8, wherein the positive temperature coefficient thermistor has a holding current rating of approximately 1.5 amperes and a trip current rating of approximately 3 amperes.

13. The device of claim 9, wherein the negative temperature coefficient thermistor has room temperature resistance of approximately one ohm or less.
